(19) United States
(12) Patent Application Publication
(10) Pub. No.: US 2025/0166611 A1
(43) Pub. Date: May 22, 2025

(54) LANGUAGE DETERMINATION METHOD AND ELECTRONIC DEVICE

(71) Applicant: Beijing Zitiao Network Technology Co., Ltd., Beijing (CN)

(72) Inventors: Bing YANG, Beijing (CN); Hongxu XU, Beijing (CN); Lei HUANG, Beijing (CN)

(21) Appl. No.: 18/927,620

(22) Filed: Oct. 25, 2024

(30) Foreign Application Priority Data
Nov. 17, 2023 (CN) 202311540579.6

(51) Int. Cl. G10L 13/08; G10L 15/06

(52) U.S. Cl. CPC G10L 13/086; G10L 15/063

(57) ABSTRACT

The present disclosure provides a language determination method and electronic device. The method includes: obtaining a first text and a reply text for the first text; determining a target sentence in the reply text; determining a first language of the first text and a second language of a preceding part of the target sentence; and determining a target language used when the target sentence is converted into speech based on the target sentence, the reply text, the first language, and the second language.

### CROSS-REFERENCE TO RELATED APPLICATION

This application claims the priority to and benefits of the Chinese Patent Application No. 202311540579.6, which was filed on Nov. 17, 2023. All the aforementioned patent applications are hereby incorporated by reference in their entireties.

### TECHNICAL FIELD

Embodiments of the present disclosure relate to the field of text processing technologies, and in particular, to a language determination method and apparatus, and an electronic device.

### BACKGROUND

An electronic device may convert a text output by a language model into speech based on a speech synthesis algorithm. During the text to speech process, the electronic device needs to accurately recognize a language used when the text is converted into the speech.

Currently, the electronic device may recognize a language of the text output by the language model, and then determine that a language of the speech is also the language of the text during the text to speech process. For example, when the text output by the language model is in Chinese, the electronic device may convert the text into Chinese speech. However, when the text includes a number, a sequence number, and etc., it is difficult for the electronic device to accurately determine the language of the text.

### SUMMARY

The present disclosure provides a language determination method and apparatus, and an electronic device, so as to solve one or more technical problems in the prior art.

According to a first aspect, the present disclosure provides a language determination method. The method includes: obtaining a first text and a reply text for the first text; determining a target sentence in the reply text; determining a first language of the first text and a second language of a preceding part of the target sentence; and determining a target language used when the target sentence is converted into speech based on the target sentence, the reply text, the first language, and the second language.

According to a second aspect, the present disclosure provides a language determination apparatus. The language determination apparatus includes an obtaining module, a first determination module, a second determination module, and a third determination module.

The obtaining module is configured to obtain a first text and a reply text for the first text.

The first determination module is configured to determine a target sentence in the reply text.

The second determination module is configured to determine a first language of the first text and a second language of a preceding part of the target sentence.

The third determination module is configured to determine a target language used when the target sentence is converted into speech based on the target sentence, the reply text, the first language, and the second language.

According to a third aspect, an embodiment of the present disclosure provides an electronic device. The electronic device includes a processor and a memory.

The memory stores computer-executable instructions.

The computer-executable instructions stored in the memory are executed by the processor, to cause the processor to perform the language determination method according to the first aspect and various possible designs of the first aspect.

According to a fourth aspect, an embodiment of the present disclosure provides a computer-readable storage medium storing computer-executable instructions that, when executed by a processor, cause the language determination method according to the first aspect and various possible designs of the first aspect to be implemented.

### BRIEF DESCRIPTION OF DRAWINGS

In order to more clearly describe the technical solutions in the embodiments of the present disclosure or in the prior art, the accompanying drawings for describing the embodiments or the prior art will be briefly described below. Apparently, the accompanying drawings in the description below show some embodiments of the present disclosure, and those of ordinary skill in the art will still derive other accompanying drawings from these accompanying drawings without any creative effort.

FIG. 1 is a schematic diagram of an application scenario according to an embodiment of the present disclosure;

FIG. 2 is a schematic flowchart of a language determination method according to an embodiment of the present disclosure;

FIG. 3 is a schematic diagram of a process of obtaining a reply text for a first text according to an embodiment of the present disclosure;

FIG. 4 is a schematic diagram of a first language and a second language according to an embodiment of the present disclosure;

FIG. 5 is a schematic diagram of a method for determining a target language according to an embodiment of the present disclosure;

FIG. 6 is a schematic diagram of determining a target language according to an embodiment of the present disclosure;

FIG. 7 is another schematic diagram of determining a target language according to an embodiment of the present disclosure;

FIG. 8 is another schematic diagram of determining a target language according to an embodiment of the present disclosure;

FIG. 9 is another schematic diagram of determining a target language according to an embodiment of the present disclosure;

FIG. 10 is a schematic diagram of a process of a language determination method according to an embodiment of the present disclosure;

FIG. 11 is a schematic diagram of a structure of a language determination apparatus according to an embodiment of the present disclosure; and

FIG. 12 is a schematic diagram of a structure of an electronic device according to an embodiment of the present disclosure.

### DETAILED DESCRIPTION

In order to make the objects, technical solutions and advantages of embodiments of the present disclosure clearer, the technical solutions in the embodiments of the present disclosure will be described clearly and completely below with reference to the accompanying drawings in the embodiments of the present disclosure. Apparently, the embodiments described are some rather than all of the embodiments of the present disclosure. All the other embodiments obtained by those of ordinary skill in the art based on the embodiments of the present disclosure without any creative effort shall fall within the scope of protection of the present disclosure.

For case of understanding, the concepts in the embodiments of the present disclosure are described below.

An electronic device is a device having a wireless transceiver function. The electronic device may be deployed on the land, including an indoor device, an outdoor device, a handheld device, a wearable device, or a vehicle-mounted device. The electronic device may be a mobile phone, a tablet computer (Pad), a computer having a wireless transceiver function, a virtual reality (VR) electronic device, an augmented reality (AR) electronic device, a wireless terminal in industrial control, a vehicle-mounted electronic device, a wireless terminal in self driving, a wireless electronic device in remote medical, a wireless electronic device in a smart grid, a wireless electronic device in transportation safety, a wireless electronic device in a smart city, a wireless electronic device in a smart home, a wearable electronic device, or the like. The electronic device in the embodiments of the present disclosure may also be referred to as a terminal, user equipment (UE), an access electronic device, a vehicle-mounted terminal, an industrial control terminal, a UE unit, a UE station, a mobile station, a mobile console, a remote station, a remote electronic device, a mobile device, a UE electronic device, a wireless communication device, a UE agent, a UE apparatus, etc. The electronic device may be fixed or mobile.

In the related art, the electronic device may convert a text output by a language model into speech based on a speech synthesis algorithm. During the text to speech process, the electronic device needs to accurately recognize a language used when the text is converted into the speech. Currently, the electronic device may directly recognize a language of the text output by the language model, and then determine the language of the text as a language of the speech during the text to speech process. For example, if the language of the text is Chinese, the speech generated by the electronic device is Chinese speech; or if the language of the text is English, the speech generated by the electronic device is English speech. However, when the text includes a number, a symbol, a formula, and etc., the electronic device cannot accurately determine the language of the text (e.g., the number may be played in English or in Chinese). As a result, the electronic device cannot accurately convert the text into the speech.

In order to solve the problem in the related art, an embodiment of the present disclosure provides a language determination method. The electronic device may obtain a first text and a reply text for the first text, and determine a target sentence in the reply text. The electronic device may determine a first language of the first text and a second language of a preceding part of the target sentence, and recognize a text in the target sentence to determine a sentence type of the target sentence. The electronic device may obtain a number of characters in the reply text, and determine a target language used when the target sentence is converted into speech, based on the number of characters, the sentence type, the first language, and the second language. In this way, the electronic device may flexibly determine, based on the number of characters and the sentence type of the target sentence, the language used when the target sentence is converted into speech. In addition, the electronic device may accurately determine, based on the language of the first text and the language of the preceding part of the target sentence, a target language used when each text in the target sentence is converted into speech. Therefore, the language recognition accuracy can be improved, and the text to speech accuracy can be improved.

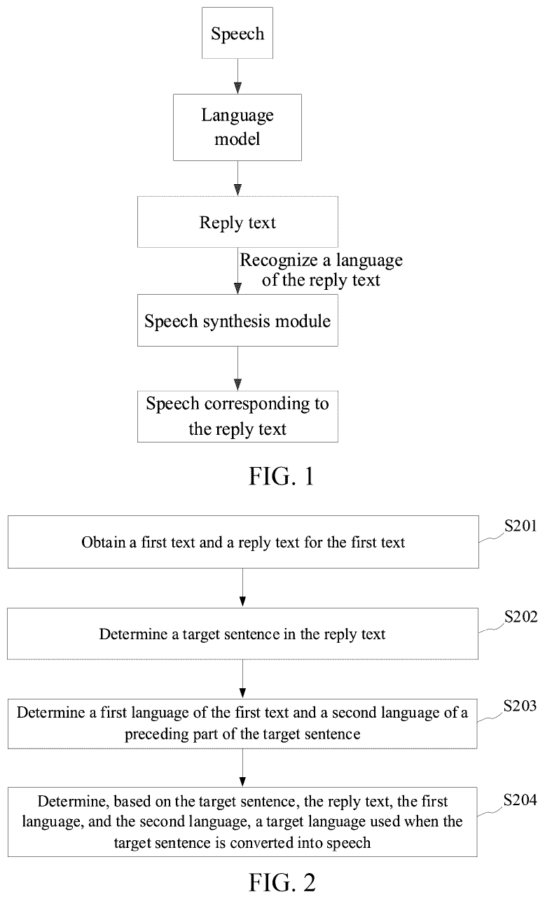

An application scenario of this embodiment of the present disclosure is described below with reference to FIG. 1.

FIG. 1 is a schematic diagram of an application scenario according to an embodiment of the present disclosure. Referring to FIG. 1, the application scenario includes speech, a language model, and a speech synthesis module. The speech synthesis module may be arranged in the electronic device, and the language model may also be arranged in the electronic device. This is not limited in this embodiment of the present disclosure. The electronic device (not shown in FIG. 1) may input the speech into the language model. The language model may determine a first text corresponding to the speech, and generate a reply text corresponding to the first text. The electronic device may recognize a language of the reply text and input the reply text and the language of the reply text into the speech synthesis module. The speech synthesis module may generate speech corresponding to the reply text. In the above method, the electronic device may accurately determine a language of each text in the reply text based on a language of the speech and the language of the reply text. Therefore, the language recognition accuracy can be improved, and the accuracy of the speech generated can be improved.

It should be noted that FIG. 1 is only an example of the application scenario of this embodiment of the present disclosure, and does not limit the application scenario of this embodiment of the present disclosure.

The technical solutions of the present disclosure and how the technical solutions of the present disclosure solve the above technical problem are described in detail below with reference to specific embodiments. The following several specific embodiments may be combined with each other, and details about same or similar concepts or processes may not be described in some embodiments again. The embodiments of the present disclosure are described below with reference to the accompanying drawings.

FIG. 2 is a schematic flowchart of a language determination method according to an embodiment of the present disclosure. Referring to FIG. 2, the method may include the following steps.

S201: Obtain a first text and a reply text for the first text.

An execution body of this embodiment of the present disclosure may be an electronic device, or a language determination apparatus arranged in an electronic device. The language determination apparatus may be implemented based on software, or may be implemented based on a combination of software and hardware. This is not limited in this embodiment of the present disclosure.

Optionally, the first text may be a text from a questioner in a dialogue, and the reply text may be a text as an answer to the first text. For example, in a dialogue scenario, the dialogue may include the questioner and an answerer, the first text may be a text associated with the questioner, and the reply text may be a text associated with the answerer. For example, a text 1 is “What is the temperature today”, and a text 2 may be “10 degrees Celsius”. In this dialogue, the text 1 may be the first text, and the text 2 may be the reply text for the first text.

Optionally, the electronic device may determine the first text based on obtained speech. For example, the electronic device may acquire speech input by a user, and then perform text recognition on the speech to obtain the first text. For example, the electronic device may receive speech sent by another device, and then perform text recognition on the speech to obtain the first text.

It should be noted that the electronic device may alternatively obtain the first text based on any other feasible implementation (e.g., the electronic device may receive the first text sent by another device). This is not limited in this embodiment of the present disclosure.

Optionally, the electronic device may obtain the reply text for the first text based on the following feasible implementation: obtaining the speech in response to a touch operation on a speech acquisition control, performing speech recognition on the speech to obtain the first text corresponding to the speech, and inputting the first text into a language model to obtain the reply text for the first text.

Optionally, the electronic device may display a question and answer page that may include the speech acquisition control. When the user clicks the speech acquisition control, the electronic device may obtain the speech. The electronic device may determine, based on a speech recognition technology, a text associated with the speech (i.e., the first text), and input the first text into the language model. The language model may determine, based on a question associated with the first text, an answer associated with the first text, to obtain the reply text for the first text.

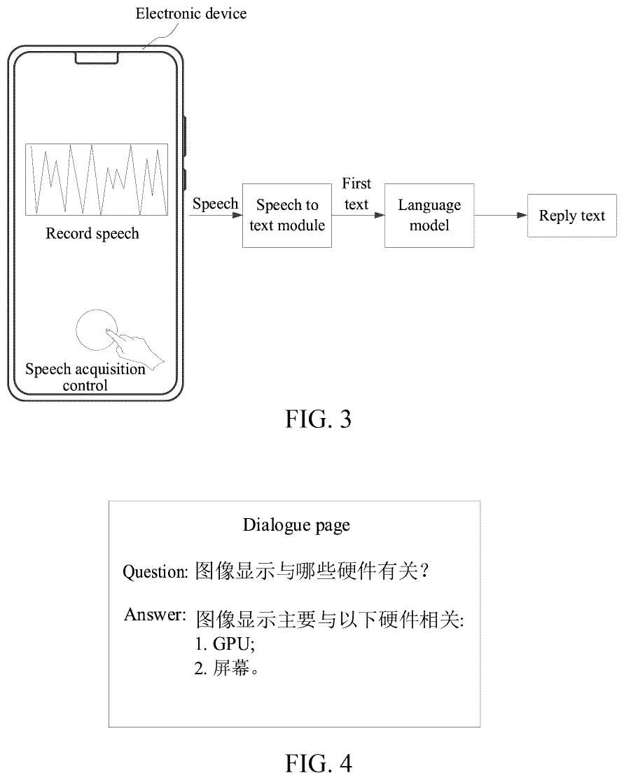

A process of obtaining the reply text for the first text is described below with reference to FIG. 3.

FIG. 3 is a schematic diagram of a process of obtaining a reply text for a first text according to an embodiment of the present disclosure. Referring to FIG. 3, the electronic device, a speech to text module, and the language model are included. A display page of the electronic device may include the speech acquisition control. When the user clicks the speech acquisition control, the electronic device may record the speech. When completing speech acquisition, the electronic device may input the acquired speech into the speech to text module. The speech to text module may process the speech to obtain the first text, and input the first text into the language model. The language model may output the reply text corresponding to the first text. In this way, the user asks the electronic device a question in a manner of the speech, and the electronic device may generate the reply text corresponding to the speech. Therefore, the diversity of interaction is improved, and the user experience is improved.

It should be noted that the speech to text module and the language model may be arranged in the electronic device (e.g., the electronic device may be a computer, a server, or another device having a terminal computing capability). This is not limited in this embodiment of the present disclosure.

S202: Determine a target sentence in the reply text.

Optionally, the target sentence may be a sentence to be subjected to speech synthesis. For example, if the electronic device performs speech synthesis on a sentence 1, the electronic device may determine the sentence 1 as the target sentence; or if the electronic device performs speech synthesis on a sentence 2, the electronic device may determine the sentence 2 as the target sentence.

After obtaining the reply text, the electronic device may divide the reply text into multiple sentences. The electronic device may determine the target sentence from the multiple sentences. For example, the reply text may be a text output by a large language model, and the text output by the large language model may be a streaming text (a text output character by character). Therefore, the electronic device may divide the streaming text to obtain multiple complete sentences.

It should be noted that the electronic device may divide the streaming text based on any feasible implementation. This is not limited in this embodiment of the present disclosure.

S203: Determine a first language of the first text and a second language of a preceding part of the target sentence.

The first language may be a language of the first text. For example, the first language may be a language of the speech input by the user. For example, if the user inputs Chinese speech, the electronic device may convert the Chinese speech into a Chinese text. That is, the first language of the first text may be Chinese.

Optionally, the second language may be a language of the preceding part of the target sentence. For example, the second language may be a language of a first sentence in the reply text, or may be a language of a preceding sentence of the target sentence. This is not limited in this embodiment of the present disclosure. For example, the target sentence is a third sentence in the reply text, and if a language of the first sentence in the reply text is Chinese, the second language may be Chinese. As another example, if the language of the preceding sentence of the target sentence is English, the second language may be English.

The first language and the second language are described below with reference to FIG. 4.

FIG. 4 is a schematic diagram of a first language and a second language according to an embodiment of the present disclosure. Referring to FIG. 4, a dialogue page is included. The dialogue page may include the questioner and the answerer. The first text input by the questioner may be “ [symbol] ”. The reply text output by the answerer may be “ [symbol] [symbol] : 1, GPU; 2, [symbol] .”

Referring to FIG. 4, the electronic device (not shown in FIG. 4) may determine that a language of the text “ [symbol] ” is Chinese, and thus may determine that the first language is Chinese. The electronic device may determine that the target sentence in the reply text may be “1. GPU” and “2, [symbol] ”. Since a language of a text of the preceding part of the target sentence, that is, “ [symbol] ”,is Chinese, the electronic device may determine that the second language is Chinese.

It should be noted that when the electronic device determines the first language and the second language, if there are multiple languages in a sentence, the electronic device may determine a language in which most text characters are as the language of the sentence. For example, the first text is a hybrid text of Chinese and English, and if the number of Chinese words is greater than the number of English words, the electronic device may determine that the language of the first text is Chinese.

It should be noted that the electronic device may determine the first language of the first text and the second language of the preceding part of the target sentence based on any feasible implementation. This is not limited in this embodiment of the present disclosure.

S204: Determine a target language used when the target sentence is converted into speech based on the target sentence, the reply text, the first language, and the second language.

The target language may be a language used when a text in the target sentence is converted into speech. For example, the target sentence may include multiple texts, and there is a corresponding language used when each of the texts is converted into speech. For example, if the target sentence is “ [symbol] 12:00 [symbol] ”, a target language of the text “ [symbol] ” in the sentence is Chinese, and a target language of the text “ [symbol] ” is also Chinese. However, the electronic device needs to accurately recognize a target language of the text “12:00”.

The electronic device may determine, based on the following feasible implementation, the target language used when each text in the target sentence is converted into speech: recognizing the text in the target sentence to determine a sentence type of the target sentence, and determining the target language used when each text in the target sentence is converted into speech, based on the sentence type, the reply text, the first language, and the second language. In this way, the electronic device may flexibly determine languages corresponding to a non-standard word, a formula, and a sequence number in the target sentence, based on the sentence type. Therefore, the language determination accuracy can be improved.

The sentence type may include at least one of the following: a non-standard word type, a formula type, a numeric type, and a standard word type. In this way, the electronic device may flexibly determine, based on the sentence type, the target language used when the text in the target sentence is converted into speech.

Optionally, the non-standard word type may indicate that the target sentence includes the non-standard word. The non-standard word may be a word including another symbol other than a character in this language and a punctuation mark. For example, the non-standard word may be a word including an Arabic number, a currency symbol, a mathematical symbol, a physical symbol, and etc. The non-standard word cannot be pronounced according to a normal pronunciation rule. For example, if the sentence is “ [symbol] 12:00”, the sentence includes a non-standard word “12:00”. For example, if the target sentence includes non-standard words such as “>” and “12:00”, the electronic device may determine that the sentence type of the target sentence is the non-standard word type.

Optionally, the formula type may indicate that the target sentence includes the formula. The formula may be a mathematical formula, a physical formula, etc. This is not limited in this embodiment of the present disclosure. The formula may include a mathematical symbol, a physical symbol, etc. For example, if the target sentence includes the mathematical formula, the physical formula, etc., the electronic device may determine that the sentence type of the target sentence is the formula type.

Optionally, the numeric type may indicate that the target sentence includes a number. Optionally, the number may be the sequence number in the target sentence. For example, there may be a sequence number before each sentence in the reply text generated by the large language model, and the sequence number may be a number in the target sentence. For example, if the target sentence includes sequence numbers such as “1” and “2”, the electronic device may determine that the sentence type of the target sentence is the numeric type.

It should be noted that the target sentence may also include any other word that cannot be pronounced according to the normal pronunciation rule. This is not limited in this embodiment of the present disclosure.

Optionally, the electronic device may perform text recognition on the target sentence to obtain the sentence type of the target sentence. The electronic device may process the target sentence based on any other feasible implementation, to obtain the sentence type of the target sentence. This is not limited in this embodiment of the present disclosure.

Optionally, if the sentence type is the non-standard word type, and the reply text includes a small number of words, the electronic device may determine that a language of the non-standard word in the target sentence is the first language; or if the sentence type is the formula type and/or the numeric type, the electronic device may determine that a language of the formula in the target sentence is the second language and that a language of the sequence number in the target sentence is the second language.

Optionally, after the electronic device determines the target language used when each text in the target sentence is converted into speech, the above language determination method further includes: performing text to speech processing on the target sentence based on the target language used when the target sentence is converted into speech, to obtain the target speech.

The electronic device may process the target sentence based on a text to speech (TTS) module, so as to obtain the target speech corresponding to the target sentence. For example, if the target sentence is “one <two”, the electronic device may determine that a target language of “one” and a target language of “two” are English and that a target language of the symbol “<” is English, and then generate English speech. In this way, the electronic device may accurately obtain, through synthesis in combination with the TTS module, the speech corresponding to the target sentence. Therefore, the speech synthesis accuracy is improved.

According to the language determination method provided in this embodiment of the present disclosure, the electronic device may obtain the first text and the reply text for the first text, and determine the target sentence in the reply text. The electronic device may determine the first language of the first text and the second language of the preceding part of the target sentence, and recognize the text in the target sentence to determine the sentence type of the target sentence, where the sentence type may include at least one of the following: the non-standard word type, the formula type, the numeric type, and the standard word type. The electronic device may determine, based on the sentence type, the reply text, the first language, and the second language, the target language used when the target sentence is converted into speech, and perform text to speech processing on the target sentence based on the target language, so as to obtain the target speech. In this way, the electronic device may flexibly and accurately determine the languages of the non-standard word, the formula, and the sequence number in the target sentence based on the sentence type of the target sentence, improving the language determination flexibility and accuracy. In addition, owing to the high accuracy of the languages of the non-standard word, the formula, and the sequence number in the target sentence, the electronic device can improve the accuracy of the generated speech associated with the target sentence.

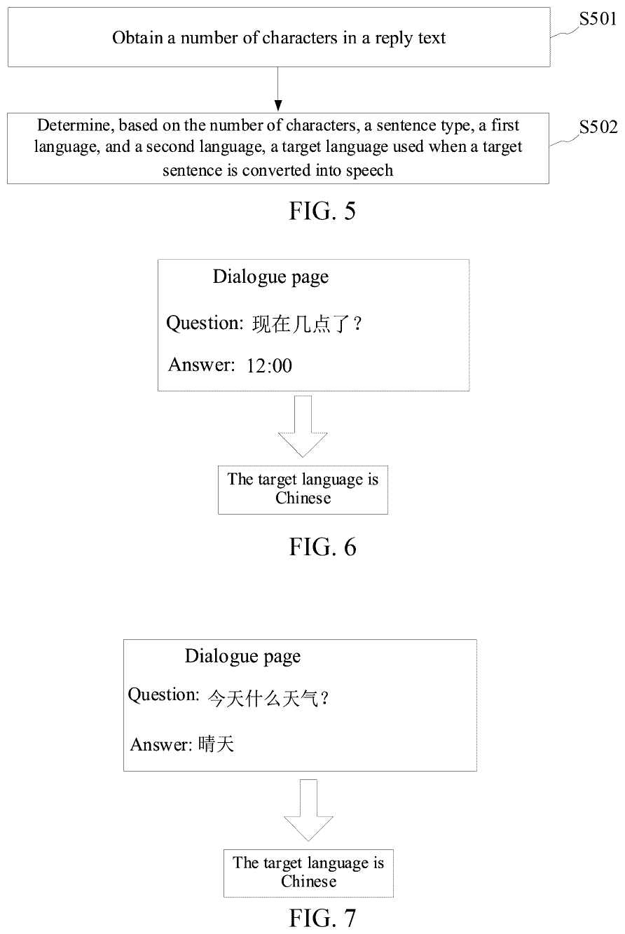

Based on the embodiment shown in FIG. 2, a method for determining, based on the sentence type, the reply text, the first language, and the second language, the target language used when each text in the target sentence is converted into speech in the above language determination method is further described below with reference to FIG. 5.

FIG. 5 is a schematic diagram of a method for determining a target language according to an embodiment of the present disclosure. Referring to FIG. 5, a process of the method may include the following steps.

S501: Obtain a number of characters in the reply text.

The number of characters may be a total number of characters in the reply text. For example, if the reply text is “ [symbol] ”, the electronic device may determine that the number of Chinese characters in the reply text is 7. For example, if reply text is “12:00”, the electronic device may determine that the number of characters in the reply text is 5 (“:” is also a character).

It should be noted that the electronic device may obtain the number of characters in the reply text based on any feasible implementation. This is not limited in this embodiment of the present disclosure.

S502: Determine the target language used when the target sentence is converted into speech, based on the number of characters, the sentence type, the first language, and the second language.

When the electronic device determines the target language used when each text in the target sentence is converted into speech, based on the number of characters, the sentence type, the first language, and the second language, there are the following two cases.

Case 1: the number of characters is less than or equal to a preset threshold.

If the number of characters is less than or equal to the preset threshold, it is determined whether the sentence type is the non-standard word type, to obtain a determination result, and the target language is determined based on the determination result. For example, if the number of characters is less than or equal to the preset threshold, it indicates that the reply text for the first text includes few characters and the electronic device cannot determine the language of the target sentence based on context information. In this case, the electronic device may accurately determine the target language corresponding to each text in the sentence, based on a result of determining whether there is the non-standard word in the sentence.

It should be noted that in this embodiment of the present disclosure, the preset threshold may be 5, so that for a reply text of an answer about time, the electronic device may accurately recognize the language of the non-standard word. Alternatively, the preset threshold may be any number. This is not limited in this embodiment of the present disclosure.

Optionally, that the electronic device determines the target language based on the determination result may be: if the determination result is that the sentence type is the non-standard word type, determining that a target language of the non-standard word in the target sentence is the first language; or if the determination result is that the sentence type is the standard word type, determining a language associated with the text in the target sentence as the target language used when the text is converted into speech.

For example, if the sentence type is the non-standard word type, and the number of characters in the reply text is less than or equal to 5, it indicates that the electronic device cannot determine the language of the non-standard word based on the context information. In this case, the electronic device may determine the first language as the language of the non-standard word. For example, the first text may be “ [symbol] ”, and the reply text corresponding to the first text may be “12:00”. In this case, the electronic device cannot determine a language of the text “12:00”. However, since the language of the first text is Chinese, the electronic device may determine that the language of the text “12:00” is Chinese.

For example, if the sentence type is the standard word type, and the reply text includes few characters, the electronic device may recognize the text in the target sentence to obtain the language associated with the text, and when the text is converted into speech, a language of the text in the speech may be the language associated with the text. For example, if the target sentence is “ [symbol] ”, the electronic device may recognize a language of the text “ [symbol] ” is Chinese, and then determine that a target language of the text “ [symbol] ” is Chinese.

A process of determining the target language of the target sentence in this case is described below with reference to FIG. 6 and FIG. 7.

FIG. 6 is a schematic diagram of determining a target language according to an embodiment of the present disclosure. Referring to FIG. 6, a dialogue page is included. The dialogue page may include the questioner and the answerer. The first text input by the questioner may be “ [symbol] ?” The reply text output by the answerer may be “12:00”. Since the reply text includes a small number of characters (5), and a sentence in the reply text includes a non-standard word “12:00”, the electronic device cannot directly determine a target language of the sentence based on “12:00”. In this case, the electronic device may determine the language of the first text as the language of the text “12:00”, that is, the target language is Chinese.

FIG. 7 is another schematic diagram of determining a target language according to an embodiment of the present disclosure. Referring to FIG. 7, a dialogue page is included. The dialogue page may include the questioner and the answerer. The first text input by the questioner may be “ [symbol] ? “The reply text output by the answerer may be “ [symbol] ”. Since the reply text includes a small number of characters (smaller than 5), and all words in a sentence in the reply text are standard words, the electronic device may directly recognize a language associated with a text in the sentence, and then determine this language as a target language used when the sentence is converted into speech, that is, the target language is Chinese.

In this way, when a short answer includes a non-standard word, the electronic device may determine, based on a language of a text of a question, a target language used when the non-standard word in the short answer is converted into speech, and when the short answer includes a standard word, the electronic device may directly recognize a language of the standard word and then determine this language as a target language used when the standard word is converted into speech. This can improve both the language determination flexibility and the accuracy of the language of the non-standard word.

Case 2: the number of characters is greater than a preset threshold.

If the number of characters is greater than the preset threshold, the target language is determined based on the sentence type and the second language. For example, when the number of characters is greater than the preset threshold, it indicates that the reply text includes a large number of characters, and the electronic device may accurately determine the target language of the target sentence based on the language of the preceding part of the target sentence. Therefore, the accuracy of the target language is improved.

The way that the electronic device determines the target language based on the sentence type and the second language may be: if the sentence type is the formula type, determining that the target language of the target sentence is the second language; if the sentence type is the numeric type, determining that the number in the target sentence is in the second language and that a target language of the other text in the target sentence is a language associated with the other text; or if the sentence type is the standard word type, determining the language associated with the text in the target sentence as the target language used when the text is converted into speech.

For example, when the reply text includes a large number of characters, if the sentence type is the formula type, it indicates that the sentence includes a formula. Therefore, the electronic device may determine the second language of a preceding part of the formula as the language used when each text in the formula is converted into speech.

It should be noted that during actual application, when dividing the reply text, the electronic device may use the formula as a sentence, or may use a consecutive non-standard word (e.g., “12:00”) as a sentence. This is not limited in this embodiment of the present disclosure.

For example, when the reply text includes a large number of characters, if the sentence type is the numeric type, it indicates that the sentence includes a sequence number followed by a text. Therefore, the electronic device may determine the second language of the preceding part of the sentence as a language of the sequence number, and determine a language associated with the text after the sequence number as a target language of the text after the sequence number. For example, if the target sentence is “ [symbol] 1, clear day, 2, rainy day”, the electronic device may determine that a target language of “clear day” and a target language of “rainy day” are English and that a target language of “1” and a target language of “2” are Chinese (because “ [symbol] ” is in Chinese).

For example, when the reply text includes a large number of characters, if the sentence type is the standard word type, the electronic device may directly recognize the language associated with the standard word in the sentence, and determine this language as the target language used when the standard word is converted into speech. For example, if the target sentence is “ [symbol] ”, the electronic device may determine that the target language of the target sentence is Chinese.

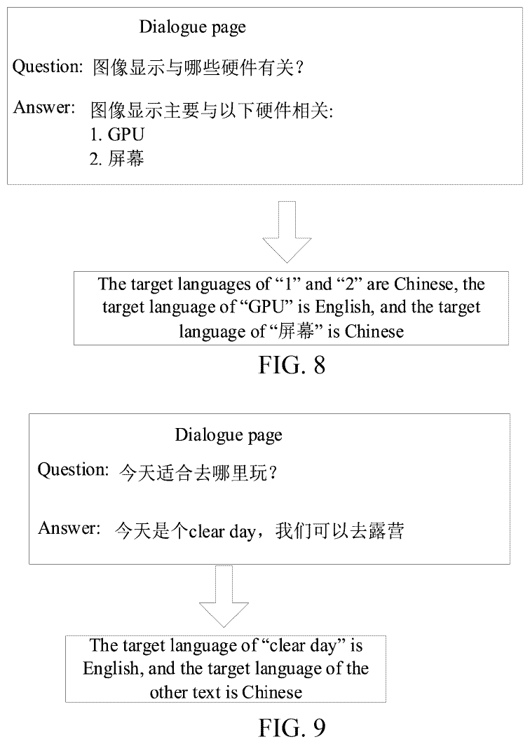

The process of determining the target language in this case is described below with reference to FIG. 8 and FIG. 9.

FIG. 8 is another schematic diagram of determining a target language according to an embodiment of the present disclosure. Referring to FIG. 8, a dialogue page is included. The dialogue page may include the questioner and the answerer. The first text input by the questioner may be “ [symbol] ?”. The reply text output by the answerer may be “ [symbol] : [symbol] 1, GPU, 2, [symbol] .”

Referring to FIG. 8, the electronic device (not shown in FIG. 8) may determine that a sentence 1 in the reply text is “ [symbol] ”, a sentence 2 is “1, GPU”, and a sentence 3 is “2, [symbol] ”. Since the sentence 2 and the sentence 3 each include a sequence number, a sentence type of the sentence 2 and a sentence type of the sentence 3 are the numeric type.

Referring to FIG. 8, since a language of the sentence 1 is Chinese, the electronic device may determine that a language of the sequence number in the sentence 2 and a language of the sequence number in the sentence 3 are Chinese. That is, the electronic device may determine that a target language of “1” and a target language of “2” are Chinese (in the prior art, since “1” is followed by “GPU”, it may be determined that the target language of “1” is English in the prior art, resulting in a poor effect of speech obtained through synthesis), a target language of “GPU” is English, and a target language of “ [symbol] ” is Chinese.

FIG. 9 is another schematic diagram of determining a target language according to an embodiment of the present disclosure. Referring to FIG. 9, a dialogue page is included. The dialogue page may include the questioner and the answerer. The first text input by the questioner may be “ [symbol] ?”. The reply text output by the answerer may be “ [symbol] clear day, [symbol] ”. The electronic device (not shown in FIG. 9) may determine that a sentence 1 in the reply text is “ [symbol] clear day “, and a sentence 2 is “ [symbol] ”. Since both a sentence type of the sentence 1 and a sentence type of the sentence 2 are the standard word type, the electronic device may determine a target language of a text in each sentence based on a language associated with the text. That is, a target language of “clear day” is English, and a target language of the other text is Chinese.

In this way, when the reply text includes a large number of characters, if the target sentence includes a sequence number, the electronic device may determine a language of the sequence number based on the language of the preceding part. Therefore, the accuracy of the language can be improved, and the speech synthesis accuracy can be improved.

According to the method for determining the target language provided in this embodiment of the present disclosure, the number of characters in the reply text is obtained. When the number of characters is less than or equal to the preset threshold, it is determined whether the sentence type is the non-standard word type, to obtain the determination result, and the target language is determined based on the determination result; or when the number of characters is greater than the preset threshold, if the sentence type is the formula type, it is determined that the target language of the target sentence is the second language; if the sentence type is the numeric type, it is determined that the number in the target sentence is in the second language and that the target language of the another text in the target sentence is the language associated with the another text; or if the sentence type is the standard word type, the language associated with the text in the target sentence is determined as the target language used when the text is converted into speech. In this way, the electronic device may flexibly determine the target language used when each text in the target sentence is converted into speech, and may accurately determine the languages of the non-standard word, the formula, and the sequence number in the target sentence. Therefore, the accuracy of the determined language is improved, and the speech synthesis accuracy can further be improved.

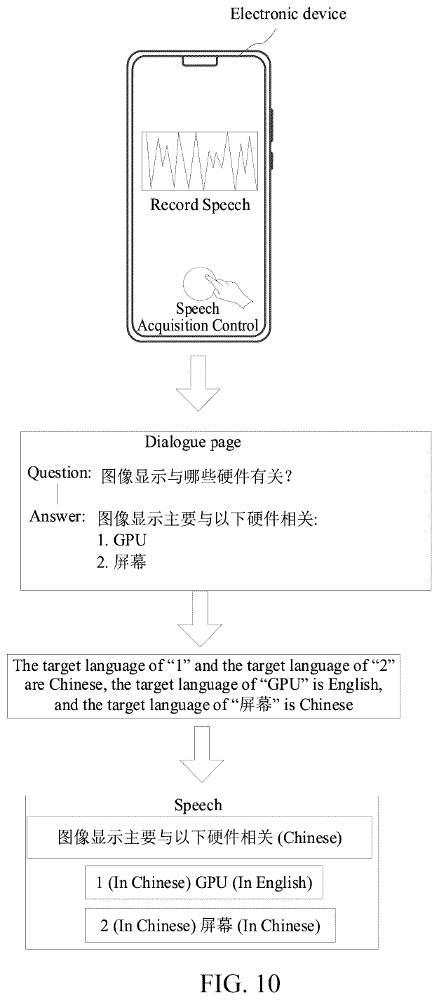

Based on any one of the above embodiments, a process of the above language determination method is described below with reference to FIG. 10.

FIG. 10 is a schematic diagram of a process of a language determination method according to an embodiment of the present disclosure. Referring to FIG. 10, the electronic device is included. The display page of the electronic device may include the speech acquisition control. When the user clicks the speech acquisition control, the electronic device may record the speech. When completing speech acquisition, the electronic device may obtain the first text of the speech, and display the first text in the dialogue page.

Referring to FIG. 10, the dialogue page may include the questioner and the answerer. The first text input by the questioner may be “ [symbol] ?? “The reply text output by the answerer may be “ [symbol] : 1, GPU, 2, [symbol] . “The electronic device may determine that the sentence 1 in the reply text is “ [symbol] [symbol] ”, the sentence 2 is “1, GPU”, and the sentence 3 is “2, [symbol] ”.

Referring to FIG. 10, since the sentence 2 and the sentence 3 each include a sequence number, the sentence type of the sentence 2 and the sentence type of the sentence 3 are the numeric type. Since the language of the sentence 1 is Chinese, the electronic device may determine that the language of the sequence number in the sentence 2 and the language of the sequence number in the sentence 3 are Chinese. That is, the electronic device may determine that the target language of “1” and the target language of “2” are Chinese, the target language of “GPU” is English, and the target language of “ [symbol] ” is Chinese.

Referring to FIG. 10, the electronic device may generate three segments of speech based on the target language of each text in the reply text. The first segment of speech may include Chinese speech of “ [symbol] ”, the second segment of speech may include Chinese speech of “1” and English speech of “GPU”, and the third segment of speech may include Chinese speech of “2” and Chinese speech of “ [symbol] ”. In this way, the electronic device may not only flexibly determine the target language of the target sentence in the reply text, but also accurately determine the target languages of the non-standard word, the formula, and the sequence number in the target sentence. Therefore, the speech synthesis accuracy is improved.

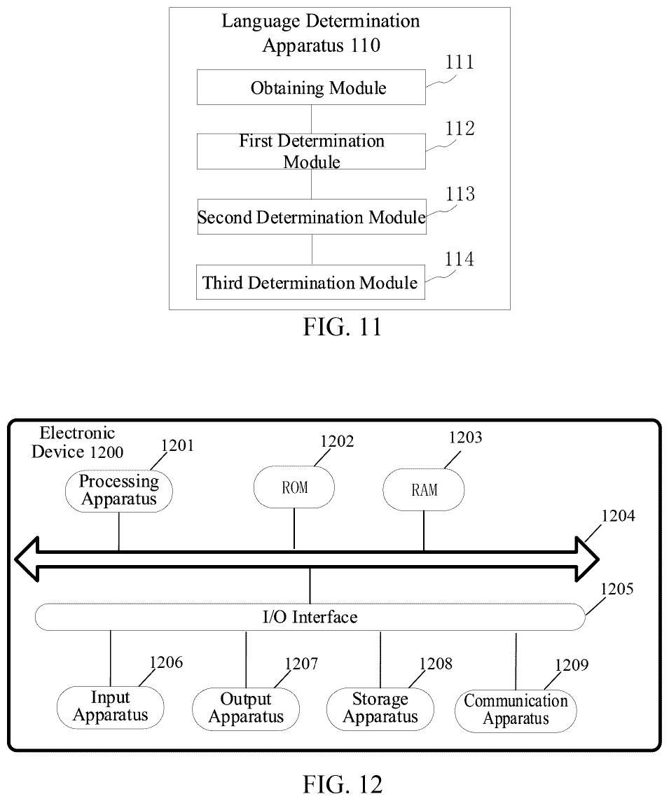

FIG. 11 is a schematic diagram of a structure of a language determination apparatus according to an embodiment of the present disclosure. Referring to FIG. 11, the language determination apparatus 110 includes an obtaining module 111, a first determination module 112, a second determination module 113, and a third determination module 114.

The obtaining module 111 is configured to obtain a first text and a reply text for the first text.

The first determination module 112 is configured to determine a target sentence in the reply text.

The second determination module 113 is configured to determine a first language of the first text and a second language of a preceding part of the target sentence.

The third determination module 114 is configured to determine a target language used when the target sentence is converted into speech based on the target sentence, the reply text, the first language, and the second language.

According to one or more embodiments of the present disclosure, the third determination module 114 is configured to: recognize a text in the target sentence to determine a sentence type of the target sentence, the sentence type including at least one of the following: a non-standard word type, a formula type, a numeric type, and a standard word type; and determine, based on the sentence type, the reply text, the first language, and the second language, a target language used when each text in the target sentence is converted into speech.

According to one or more embodiments of the present disclosure, the third determination module 114 is configured to: obtain a number of characters in the reply text; and determine, based on the number of characters, the sentence type, the first language, and the second language, the target language used when each text in the target sentence is converted into speech.

According to one or more embodiments of the present disclosure, the third determination module 114 is configured to: if the number of characters is less than or equal to a preset threshold, determine whether the sentence type is the non-standard word type, to obtain a determination result, and determine the target language based on the determination result; or if the number of characters is greater than a preset threshold, determine the target language based on the sentence type and the second language.

According to one or more embodiments of the present disclosure, the third determination module 114 is configured to: if the determination result is that the sentence type is the non-standard word type, determine that a target language of a non-standard word in the target sentence is the first language; or if the determination result is that the sentence type is the standard word type, determine a language associated with the text in the target sentence as a target language used when the text is converted into speech.

According to one or more embodiments of the present disclosure, the third determination module 114 is configured to: if the sentence type is the formula type, determine that the target language of the target sentence is the second language; if the sentence type is the numeric type, determine that a number in the target sentence is in the second language and that a target language of another text in the target sentence is a language associated with the another text; or if the sentence type is the standard word type, determine the language associated with the text in the target sentence as the target language used when the text is converted into speech.

According to one or more embodiments of the present disclosure, the obtaining module 111 is configured to: obtain speech in response to a touch operation on the speech acquisition control; perform speech recognition on the speech to obtain the first text corresponding to the speech; and input the first text into a language model to obtain the reply text for the first text.

According to one or more embodiments of the present disclosure, the third determination module 114 is further configured to: perform text to speech processing on the target sentence based on the target language used when the target sentence is converted into speech, to obtain target speech.

The language determination apparatus provided in this embodiment may be configured to perform the technical solution of the above method embodiment. The implementation principle and technical effects thereof are similar, and are not described herein again in this embodiment.

FIG. 12 is a schematic diagram of a structure of an electronic device according to an embodiment of the present disclosure. Reference is made to FIG. 12, which is a schematic diagram of a structure of an electronic device 1200 suitable for implementing an embodiment of the present disclosure. The electronic device may include, but is not limited to, a mobile terminal such as a mobile phone, a notebook computer, a digital broadcast receiver, a personal digital assistant (PDA), a tablet computer (portable Android device, PAD), a portable media player (PMP), and a vehicle-mounted terminal (such as a vehicle navigation terminal), and a fixed terminal such as a digital TV and a desktop computer. The electronic device as shown in FIG. 12 is merely an example, and shall not impose any limitation on the function and scope of use of the embodiments of the present disclosure.

As shown in FIG. 12, the electronic device 1200 may include a processing apparatus (e.g., a central processing unit or a graphics processing unit) 1201 that may perform a variety of appropriate actions and processing in accordance with a program stored in a read-only memory (ROM) 1202 or a program loaded from a storage apparatus 1208 into a random-access memory (RAM) 1203. The RAM 1203 further stores various programs and data required for the operation of the electronic device 1200. The processing apparatus 1201, the ROM 1202, and the RAM 1203 are connected to each other through a bus 1204. An input/output (I/O) interface 1205 is also connected to the bus 1204.

Generally, the following apparatuses may be connected to the I/O interface 1205: an input apparatus 1206 including, for example, a touchscreen, a touchpad, a keyboard, a mouse, a camera, a microphone, an accelerometer, and a gyroscope; an output apparatus 1207 including, for example, a liquid crystal display (LCD), a speaker, and a vibrator; the storage apparatus 1208 including, for example, a tape and a hard disk; and a communication apparatus 1209. The communication apparatus 1209 may allow the electronic device 1200 to perform wireless or wired communication with other devices to exchange data. Although FIG. 12 shows the electronic device 1200 having various apparatuses, it should be understood that it is not required to implement or have all of the shown apparatuses. It may be an alternative to implement or have more or fewer apparatuses.

In particular, according to an embodiment of the present disclosure, the process described above with reference to the flowchart may be implemented as a computer software program. For example, this embodiment of the present disclosure includes a computer program product, which includes a computer program carried on a computer-readable medium, where the computer program includes program code for performing the method shown in the flowchart. In such an embodiment, the computer program may be downloaded from a network through the communication apparatus 1209 and installed, installed from the storage apparatus 1208, or installed from the ROM 1202. The computer program, when executed by the processing apparatus 1201, causes the above-mentioned functions defined in the method according to the embodiments of the present disclosure to be performed.

According to the language determination method and apparatus, and the electronic device provided in the present disclosure, the electronic device may obtain the first text and the reply text for the first text, determine the target sentence in the reply text, determine the first language of the first text and the second sentence of the preceding part of the target sentence, and determine, based on the target sentence, the reply text, the first language, and the second language, the target language used when the target sentence is converted into speech. In the above method, the electronic device may accurately determine, based on the language of the first text and the language of the preceding part of the target sentence in the reply text for the first text, a target language used when each text in the target sentence is converted into speech. Therefore, the electronic device can improve the language recognition accuracy and further improve the accuracy of speech obtained through synthesis.

It should be noted that the above computer-readable medium described in the present disclosure may be a computer-readable signal medium, a computer-readable storage medium, or any combination thereof. The computer-readable storage medium may be, for example but not limited to, electric, magnetic, optical, electromagnetic, infrared, or semiconductor systems, apparatuses, or devices, or any combination thereof. A more specific example of the computer-readable storage medium may include, but is not limited to: an electrical connection having one or more wires, a portable computer magnetic disk, a hard disk, a random-access memory (RAM), a read-only memory (ROM), an erasable programmable read-only memory (EPROM) (or a flash memory), an optical fiber, a portable compact disc read-only memory (CD-ROM), an optical storage device, a magnetic storage device, or any suitable combination thereof. In the present disclosure, the computer-readable storage medium may be any tangible medium containing or storing a program which may be used by or in combination with an instruction execution system, apparatus, or device. In the present disclosure, the computer-readable signal medium may include a data signal propagated in a baseband or as a part of a carrier, the data signal carrying computer-readable program code. The propagated data signal may be in various forms, including but not limited to an electromagnetic signal, an optical signal, or any suitable combination thereof. The computer-readable signal medium may further be any computer-readable medium other than the computer-readable storage medium. The computer-readable signal medium can send, propagate, or transmit a program used by or in combination with an instruction execution system, apparatus, or device. The program code contained in the computer-readable medium may be transmitted by any suitable medium, including but not limited to: electric wires, optical cables, radio frequency (RF), etc., or any suitable combination thereof.

The above computer-readable medium may be contained in the above electronic device. Alternatively, the computer-readable medium may exist independently, without being assembled into the electronic device.

The above computer-readable medium carries one or more programs that, when executed by the electronic device, cause the electronic device to perform the method shown in the above embodiment.

An embodiment of the present disclosure provides a computer-readable storage medium storing computer-executable instructions that, when executed by a processor, cause the method according to various possible designs of the above embodiments to be implemented.

An embodiment of the present disclosure provides a computer program product including a computer program that, when executed by a processor, causes the method according to various possible designs of the above embodiments to be implemented.

The computer program code for performing the operations in the present disclosure may be written in one or more programming languages or a combination thereof, where the programming languages include an object-oriented programming language, such as Java, Smalltalk, or C++, and further include conventional procedural programming languages, such as “C” language or similar programming languages. The program code may be completely executed on a computer of a user, partially executed on a computer of a user, executed as an independent software package, partially executed on a computer of a user and partially executed on a remote computer, or completely executed on a remote computer or server. In the case of the remote computer, the remote computer may be connected to the computer of the user via any kind of network, including a local area network (LAN) or a wide area network (WAN), or may be connected to an external computer (for example, connected via the Internet with the aid of an Internet service provider).

The flowchart and block diagram in the accompanying drawings illustrate the possibly implemented architecture, functions, and operations of the system, method, and computer program product according to various embodiments of the present disclosure. In this regard, each block in the flowchart or block diagram may represent a module, program segment, or part of code, and the module, program segment, or part of code contains one or more executable instructions for implementing the specified logical functions. It should also be noted that, in some alternative implementations, the functions marked in the blocks may also occur in an order different from that marked in the accompanying drawings. For example, two blocks shown in succession can actually be performed substantially in parallel, or they can sometimes be performed in the reverse order, depending on the functions involved. It should also be noted that each block in the block diagram and/or the flowchart, and a combination of the blocks in the block diagram and/or the flowchart may be implemented by a dedicated hardware-based system that executes specified functions or operations, or may be implemented by a combination of dedicated hardware and computer instructions.

The related units described in the embodiments of the present disclosure may be implemented by software, or may be implemented by hardware. Names of the units do not constitute a limitation on the units themselves in some cases, for example, a first obtaining unit may alternatively be described as “a unit for obtaining at least two internet protocol addresses”.

The functions described herein above may be performed at least partially by one or more hardware logic components. For example, without limitation, exemplary types of hardware logic components that may be used include: a field programmable gate array (FPGA), an application-specific integrated circuit (ASIC), an application-specific standard product (ASSP), a system-on-chip (SOC), a complex programmable logic device (CPLD), and the like.

In the context of the present disclosure, a machine-readable medium may be a tangible medium that may contain or store a program used by or in combination with an instruction execution system, apparatus, or device. The machine-readable medium may be a machine-readable signal medium or a machine-readable storage medium. The machine-readable medium may include, but is not limited to, an electronic, magnetic, optical, electromagnetic, infrared, or semiconductor system, apparatus, or device, or any suitable combination thereof. More specific examples of the machine-readable storage medium may include an electrical connection based on one or more wires, a portable computer disk, a hard disk, a random access memory (RAM), a read-only memory (ROM), an erasable programmable read-only memory (EPROM) (or a flash memory), an optic fiber, a portable compact disc read-only memory (CD-ROM), an optical storage device, a magnetic storage device, or any suitable combination thereof.

It should be noted that the modifiers “one” and “a plurality of” mentioned in the present disclosure are illustrative and not restrictive, and those skilled in the art should understand that unless the context clearly indicates otherwise, the modifiers should be understood as “one or more”.

The names of messages or information exchanged between a plurality of apparatuses in the implementations of the present disclosure are used for illustrative purposes only, and are not used to limit the scope of these messages or information.

It can be understood that before the use of the technical solutions disclosed in the embodiments of the present disclosure, the user shall be informed of the type, range of use, use scenarios, etc., of personal information involved in the present disclosure in an appropriate manner in accordance with the relevant laws and regulations, and the authorization of the user shall be obtained.

For example, in response to reception of an active request from the user, prompt information is sent to the user to clearly inform the user that a requested operation will require access to and use of the personal information of the user. As such, the user can independently choose, based on the prompt information, whether to provide the personal information to software or hardware, such as an electronic device, an application, a server, or a storage medium, that performs operations in the technical solutions of the present disclosure. As an optional but non-limiting implementation, in response to the reception of the active request from the user, the prompt information may be sent to the user in the form of, for example, a pop-up window, in which the prompt information may be presented in text. Furthermore, the pop-up window may further include a selection control for the user to choose whether to “agree” or “disagree” to provide the personal information to the electronic device.

It can be understood that the above process of notifying and obtaining the authorization of the user is only illustrative and does not constitute a limitation on the implementations of the present disclosure, and other manners that satisfy the relevant laws and regulations may also be applied in the implementations of the present disclosure.

It can be understood that the data involved in the technical solutions (including, but not limited to, the data itself and the access to or use of the data) shall comply with the requirements of corresponding laws, regulations, and relevant provisions. The data may include information, parameters, messages, etc., such as traffic switching indication information.

The foregoing descriptions are merely preferred embodiments of the present disclosure and explanations of the applied technical principles. Those skilled in the art should understand that the scope of disclosure involved in the present disclosure is not limited to the technical solutions formed by specific combinations of the foregoing technical features, and shall also cover other technical solutions formed by any combination of the foregoing technical features or equivalent features thereof without departing from the foregoing concept of disclosure. For example, a technical solution formed by a replacement of the foregoing features with technical features with similar functions disclosed in the present disclosure (but not limited thereto) also falls within the scope of the present disclosure.

In addition, although the various operations are depicted in a specific order, it should not be construed as requiring these operations to be performed in the specific order shown or in a sequential order. Under certain circumstances, multitasking and parallel processing may be advantageous. Similarly, although several specific implementation details are included in the foregoing discussions, these details should not be construed as limiting the scope of the present disclosure. Some features that are described in the context of separate embodiments can also be implemented in combination in a single embodiment. In contrast, various features described in the context of a single embodiment may alternatively be implemented in a plurality of embodiments individually or in any suitable subcombination.

Although the subject matter has been described in a language specific to structural features and/or logical actions of the method, it should be understood that the subject matter defined in the appended claims is not necessarily limited to the specific features or actions described above. In contrast, the specific features and actions described above are merely exemplary forms of implementing the claims.

1. A language determination method, comprising:
obtaining a first text and a reply text for the first text;
determining a target sentence in the reply text;
determining a first language of the first text and a second language of a preceding part of the target sentence; and
determining a target language used when the target sentence is converted into speech based on the target sentence, the reply text, the first language, and the second language.

2. The method according to claim 1, wherein the determining a target language used when the target sentence is converted into speech based on the target sentence, the reply text, the first language, and the second language comprises:
recognizing a text in the target sentence to determine a sentence type of the target sentence, the sentence type comprising at least one of the following: a non-standard word type, a formula type, a numeric type, and a standard word type; and
determining, based on the sentence type, the reply text, the first language, and the second language, the target language used when the target sentence is converted into speech.

3. The method according to claim 2, wherein the determining, based on the sentence type, the reply text, the first language, and the second language, the target language used when the target sentence is converted into speech comprises:
obtaining a number of characters in the reply text; and
determining, based on the number of characters, the sentence type, the first language, and the second language, the target language used when the target sentence is converted into speech.

4. The method according to claim 3, wherein the determining, based on the number of characters, the sentence type, the first language, and the second language, the target language used when the target sentence is converted into speech comprises:
determining, in response to the number of characters being less than or equal to a preset threshold, whether the sentence type is the non-standard word type, to obtain a determination result, and determining the target language based on the determination result; or
determining, in response to the number of characters being greater than a preset threshold, the target language based on the sentence type and the second language.

5. The method according to claim 4, wherein the determining the target language based on the determination result comprises:
determining, in response to the determination result being that the sentence type is the non-standard word type, that a target language of a non-standard word in the target sentence is the first language; or
determining, in response to the determination result being that the sentence type is the standard word type, a language associated with the text in the target sentence as a target language used when the text is converted into speech.

6. The method according to claim 4, wherein the determining the target language based on the sentence type and the second language comprises:
determining, in response to the sentence type being the formula type, that the target language of the target sentence is the second language;
determining, in response to the sentence type being the numeric type, that a number in the target sentence is in the second language and that a target language of the other text in the target sentence is a language associated with the other text; or
determining, in response to the sentence type being the standard word type, the language associated with the text in the target sentence as the target language used when the text is converted into speech.

7. The method according to any one of claim 1, wherein the obtaining a reply text for the first text comprises:
obtaining speech in response to a touch operation on a speech acquisition control;
performing speech recognition on the speech to obtain the first text corresponding to the speech; and
inputting the first text into a language model to obtain the reply text for the first text.

8. The method according to any one of claim 1, wherein after the determining a target language used when the target sentence is converted into speech, the method further comprises:
performing text to speech processing on the target sentence based on the target language used when the target sentence is converted into speech, to obtain target speech.

9. An electronic device, comprising:
a processor; and
a memory, configured to store computer-executable instructions,
wherein the computer-executable instructions stored in the memory, when executed by the processor, cause the processor to:
obtain a first text and a reply text for the first text;
determine a target sentence in the reply text;
determine a first language of the first text and a second language of a preceding part of the target sentence; and
determine a target language used when the target sentence is converted into speech based on the target sentence, the reply text, the first language, and the second language.

10. The electronic device according to claim 9, wherein the processor is further caused to:
recognize a text in the target sentence to determine a sentence type of the target sentence, the sentence type comprising at least one of the following: a non-standard word type, a formula type, a numeric type, and a standard word type; and
determine, based on the sentence type, the reply text, the first language, and the second language, the target language used when the target sentence is converted into speech.

11. The electronic device according to claim 10, wherein the processor is further caused to:
obtain a number of characters in the reply text; and
determine, based on the number of characters, the sentence type, the first language, and the second language, the target language used when the target sentence is converted into speech.

12. The electronic device according to claim 11, wherein the processor is further caused to:
determine, in response to the number of characters being less than or equal to a preset threshold, whether the sentence type is the non-standard word type, to obtain a determination result, and determining the target language based on the determination result; or
determine, in response to the number of characters being greater than a preset threshold, the target language based on the sentence type and the second language.

13. The electronic device according to claim 12, wherein the processor is further caused to:
determine, in response to the determination result being that the sentence type is the non-standard word type, that a target language of a non-standard word in the target sentence is the first language; or
determine, in response to the determination result being that the sentence type is the standard word type, a language associated with the text in the target sentence as a target language used when the text is converted into speech.

14. The electronic device according to claim 12, wherein the processor is further caused to:
determine, in response to the sentence type being the formula type, that the target language of the target sentence is the second language;
determine, in response to the sentence type being the numeric type, that a number in the target sentence is in the second language and that a target language of the other text in the target sentence is a language associated with the other text; or
determine, in response to the sentence type being the standard word type, the language associated with the text in the target sentence as the target language used when the text is converted into speech.

15. The electronic device according to claim 9, wherein the processor is further caused to:
obtain speech in response to a touch operation on a speech acquisition control;
perform speech recognition on the speech to obtain the first text corresponding to the speech; and
input the first text into a language model to obtain the reply text for the first text.

16. The electronic device according to claim 9, wherein after determine a target language used when the target sentence is converted into speech, the processor is further caused to:
perform text to speech processing on the target sentence based on the target language used when the target sentence is converted into speech, to obtain target speech.

17. A computer-readable storage medium storing computer-executable instructions that, when executed by a processor, cause the processor to:
obtain a first text and a reply text for the first text;
determine a target sentence in the reply text;
determine a first language of the first text and a second language of a preceding part of the target sentence; and
determine a target language used when the target sentence is converted into speech based on the target sentence, the reply text, the first language, and the second language.

18. The computer-readable storage medium according to claim 17, wherein the processor is further caused to:
recognize a text in the target sentence to determine a sentence type of the target sentence, the sentence type comprising at least one of the following: a non-standard word type, a formula type, a numeric type, and a standard word type; and
determine, based on the sentence type, the reply text, the first language, and the second language, the target language used when the target sentence is converted into speech.

19. The computer-readable storage medium according to claim 18, wherein the processor is further caused to:
obtain a number of characters in the reply text; and
determine, based on the number of characters, the sentence type, the first language, and the second language, the target language used when the target sentence is converted into speech.

20. The computer-readable storage medium according to claim 19, wherein the processor is further caused to:
determine, in response to the number of characters being less than or equal to a preset threshold, whether the sentence type is the non-standard word type, to obtain a determination result, and determining the target language based on the determination result; or
determine, in response to the number of characters being greater than a preset threshold, the target language based on the sentence type and the second language.
